(19) United States
(12) Patent Application Publication
(10) Pub. No.: US 2007/0200368 A1
(43) Pub. Date: Aug. 30, 2007

(54) Compartment door latch mechanism

(75) Inventor: Karl J. Bauer, Garner, IA (US)

Correspondence Address: FOLEY & LARDNER LLP, 777 EAST WISCONSIN AVENUE, MILWAUKEE, WI, 53202-5306, US

(73) Assignee: Oshkosh Truck Corporation

(21) Appl. No.: 11/604,648

(22) Filed: Nov. 27, 2006

Related U.S. Application Data
(60) Provisional application No. 60/740,057, filed on Nov. 28, 2005.

(51) Int. Cl. E05B 3/00

(52) U.S. Cl. 292/336.3

(57) ABSTRACT

A compartment door latch mechanism requiring low amounts of torque to close the mechanism. The mechanism includes a top latch rod and a bottom latch rod. The top latch rod and the bottom latch rod are coupled to a plate via associated latch rod pins. The plate is coupled to a shaft around which the plate is capable of rotating the latch mechanism includes a lever suitably configured to facilitate the rotating of the plate. The geometry of the lever suitably provides a decreasing output and increasing input effective lever arms. The latch rod pins are positioned so as to engage the rods in a closed position at substantially 12:00 and 6:00 positions, respectively. In addition, the latch rod pins are further positioned so as to engage the rods in an open position at substantially 9:00 and 3:00 positions, respectively.

### CROSS-REFERENCE TO RELATED PATENT APPLICATIONS

This application claims priority from Provisional Application U.S. Application 60/740,057, filed Nov. 28, 2005, incorporated herein by reference in its entirety.

### BACKGROUND OF THE INVENTION

This invention is directed to a compartment door latch mechanism; more particularly, to a compartment door latch mechanism requiring lower torque to engage the associated door latch rods in a door latch close position and in a door latch open position.

Mobile truck bodies are typically modular in design and include at least two side packs. These side packs each include one or more storage compartments, suitably configured to enclose tools, equipment, and the like. The most common side pack compartment doors include a latch mechanism, which is difficult to turn when approaching a completely closed or completely open position. These common latch mechanisms generally require a large amount of torque. In addition, the amount of torque necessarily increases significantly as the latch mechanisms comes closer to a completely closed or completely open position.

Thus, there is a need for a latch mechanism requiring less torque to engage the associated door latch rods in a door latch close position and in a door latch open position.

There is also a need for a latch mechanism in which the torque decreases as the latch mechanism approaches a completely close or completely open position.

### SUMMARY OF THE INVENTION

There is provided a compartment door latch mechanism. Further, there is provided a compartment door latch mechanism requiring less torque to engage the associated door latch rods in a door latch close position and in a door latch open position. Still further, there is provided a compartment door latch mechanism requiring less torque to raise and lower associated door latch rods.

There is provided a compartment door latch mechanism including a support plate rotatably mounted on a shaft and at least two latch rod pins affixed to the support plate at substantially equal predetermined distances from the shaft. The at least two latch rod pins extend substantially orthogonally from the support plate. The compartment door latch mechanism further includes a first latch rod and a second latch rod coupled to the support plate via respective associated latch rod pins. The first and second latch rods have respective substantially opposed initial orientations. The compartment door latch mechanism also includes a handle configured to facilitate the rotating of the support plate. The first and second latch rods are configured to transplace in a plane substantially parallel to the support plate to be engaged in a door latch close position and in a door latch open position. The handle, the first latch rod, and the second latch rod are spatially disposed such that in the door latch close position a projection of the handle onto a plane associated with the support plate is characterized by a first predetermined angular position relative to a projection onto the plane associated with the support plate of at least one of the first latch rod and the second latch rod. Preferably, in the door latch open position the projection of the handle onto the plane associated with the support plate of the at least one of the first latch rod and the second latch rod. In addition, the first and second latch rods are configured to maintain their respective initial orientations during operation of the door latch mechanism.

Still further, there is provided a compartment door latch mechanism, comprising a support member adapted for rotating under an influence of input force and a latch coupled to the support member. The latch is adapted for transplacing in a plane substantially parallel to the support member to be engaged in a door latch close position and in a door latch open position. The compartment door latch mechanism also comprises a lever including a first arm and at least one second arm. The first arm is configured for receiving input force and is characterized by a first effective length. The at least one second arm is adapted for delivering output force to the latch and is characterized a second effective length. The lever is configured for respective changing of the effective lengths of the first and the at least one second lever arms such that the input force necessary for transplacing the latch continuously decreases as the latch advances to at least the door latch close position. The compartment door latch mechanism, preferably, includes a handle member attached to the support member. The support member is rotatably mounted on a shaft, which serves as the lever fulcrum. A radial portion of the support member extending from the shaft to the handle member in conjunction with the handle member serves as the first lever arm, wherein a radial portion of the support member extending from the shaft to the point of coupling of the latch to the support member serves as the at least one second lever arm.

There is further provided a vehicle comprising a support platform. A support member is coupled to the support platform and configured to engage a surface. A compartment is coupled to the support platform and including a door. A compartment door latch mechanism is coupled to the door. The compartment door latch mechanism comprises a support plate rotatably mounted on a shaft and coupled to the door. At least two latch rod pins are affixed to the support plate at substantially equal predetermined distances from the shaft, the at least two latch rod pins extending substantially orthogonally from the support plate. A first latch rod and a second latch rod are coupled to the support plate via respective associated latch rod pins, the first and second latch rods having respective substantially opposed initial orientations. A handle is configured to facilitate the rotating of the support plate. Wherein the first and second latch rods are configured to transplace in a plane substantially parallel to the support plate to be engaged in a door latch close position and in a door latch open position. Wherein the handle, the first latch rod, and the second latch rod are spatially disposed such that in the door latch close position a projection of the handle into a plant associated with the support plate is characterized by a first predetermined angular position relative to a projection onto the plane associated with the support plate of at least one of the first latch rod and the second latch rod.

Still other aspects of the present invention will become readily apparent to those skilled in this art from the following description wherein there is shown and described a preferred embodiment of this invention, simply by way of illustration of one of the best modes suited for to carry out the invention. As it will be realized by those skilled in the art, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is an isometric view of a door latch mechanism opened at substantially 9:00 and 3:00 rod position;

FIG. 2 is an isometric view of the door latch mechanism illustrated in FIG. 1 partially closed at a 10:30 and 4:30 rod pin position;

FIG. 3 is an isometric view of the door latch mechanism illustrated in FIG. 1 closed at substantially a 12:00 and 6:00 rod position.

FIG. 4 is a schematic illustration of a truck type vehicle having a storage compartment with a door including an exemplary embodiment of a door latch mechanism.

### DETAILED DESCRIPTION OF THE PREFERRED EMBODIMENTS

There is disclosed a compartment door latch mechanism. In particular, a compartment door latch mechanism requiring less torque to engage the associated door latch rods in a door latch close position and in a door latch open position. In a preferred embodiment the latch mechanism is coupled to at least one compartment door on a mobile truck body. Also, in a preferred embodiment, the initial orientation of the first latch rod is an upward orientation, and the initial orientation of the second latch rod is a downward orientation. Those skilled in the art will appreciate that the door latch mechanism is also capable of being applied to other doors requiring locking mechanisms, and the instant description of a compartment door on a truck body, as well as the description of a latch mechanism with upward and downward oriented latch rods, is for illustration and example purposes only. It should be understood that the door latch mechanism can also be orientated to engage a door locking slot in a horizontal configuration.

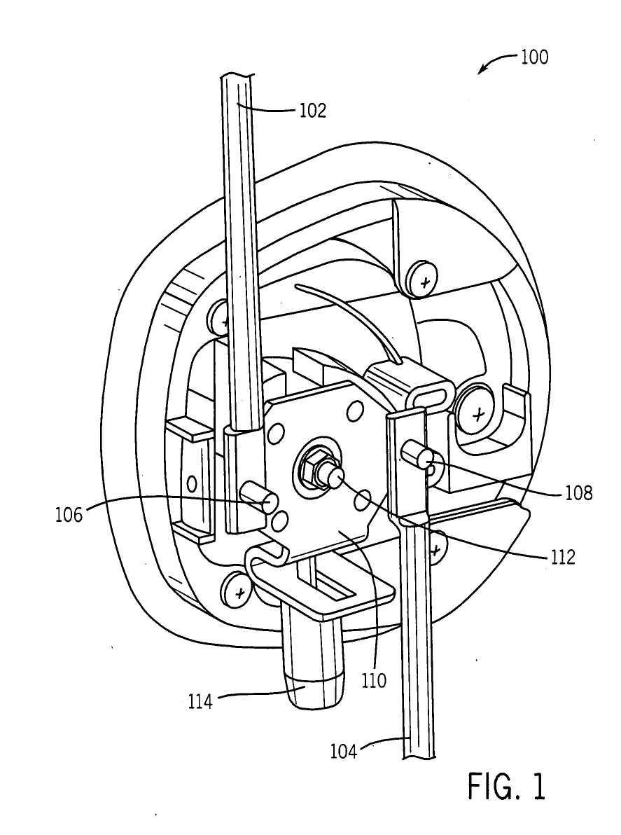

Turning now to FIG. 1, there is shown an isometric view of a latch mechanism 100 for a truck body compartment door in accordance with the present invention. The latch mechanism 100 includes at least two latch rods, illustrated in FIG. 1 as a top latch rod 102 and a bottom latch rod 104. As illustrated in FIG. 1, the top latch rod 102 has an upward orientation, and the bottom latch rod 104 has a downward orientation. The mechanism 100 also includes a support plate 110, from which perpendicularly extend a top rod latch pin 106 and a bottom rod latch pin 108. The top rod latch pin 106 and the bottom rod latch pin 108 are fixedly attached to the support plate 110. It will be appreciated by those skilled in the art that the top rod 102 and the bottom rod 104 are coupled to the support plate via respective associated latch rod pins 106 and 108, and maintain their respective initial orientations during operation of the latch mechanism 100.

The skilled artisan will appreciate that as shown in FIG. 1, the rod latch pins 106 and 108 are at the 9:00 and 3:00 position, respectively, indicating that the latch mechanism 100 is in the open position. It will be also appreciated by those skilled in the art that to close the latch mechanism 100 of FIG. 1, a force is suitably applied to the handle 114, which functions to rotate clockwise the support plate 110 around the shaft 112. In turn, the rotation of the support plate 110 serves to turn the rod latch pins 106 and 108 so as to force the latch rods 102 and 104 to extend, respectively, in an upward and downward direction, thereby engaging the distal end of each of the latch rods 102 and 104 into a corresponding locking slot (not shown) of the compartment door. The skilled artisan will appreciate that in the geometry of the instant latch mechanism 100 the handle 114, being attached to the support plate 110, together with a respective radial portion of the support plate 110, suitably serves as a first lever arm with the shaft 112 serving as a fulcrum. A radial portion of the support plate 110 between the shaft 112 and a respective rod latch pin 106 and 108 suitably serves as a second lever arm. As will be recognized by those skilled in the art, as the handle 114 is moved clockwise, the effective length of the first lever arm (input server arm) increases, whereas the effective length of the second lever arm (output lever arm) decreases. Thus, as the handle 114 is moved clockwise, i.e. as the compartment door latch mechanism approaches the door latch close position, the less force is required to turn the handle 114.

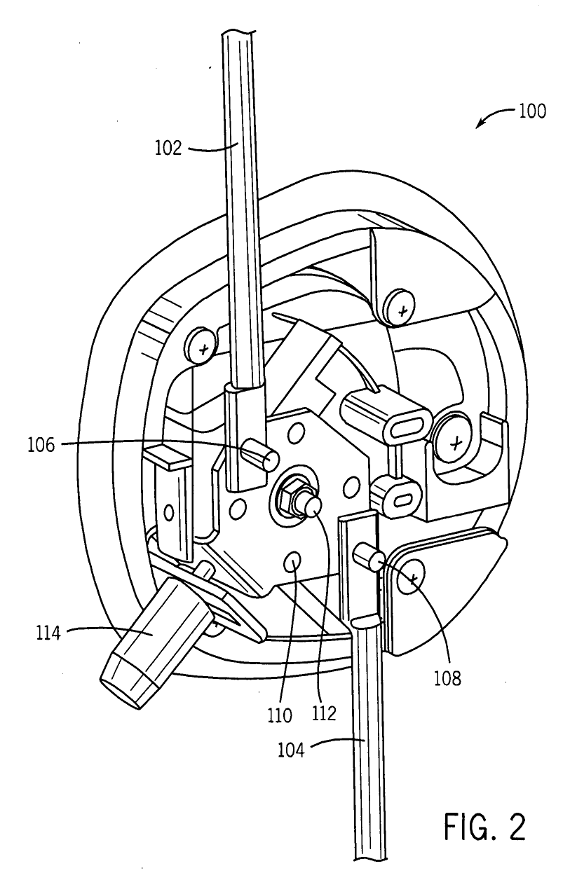

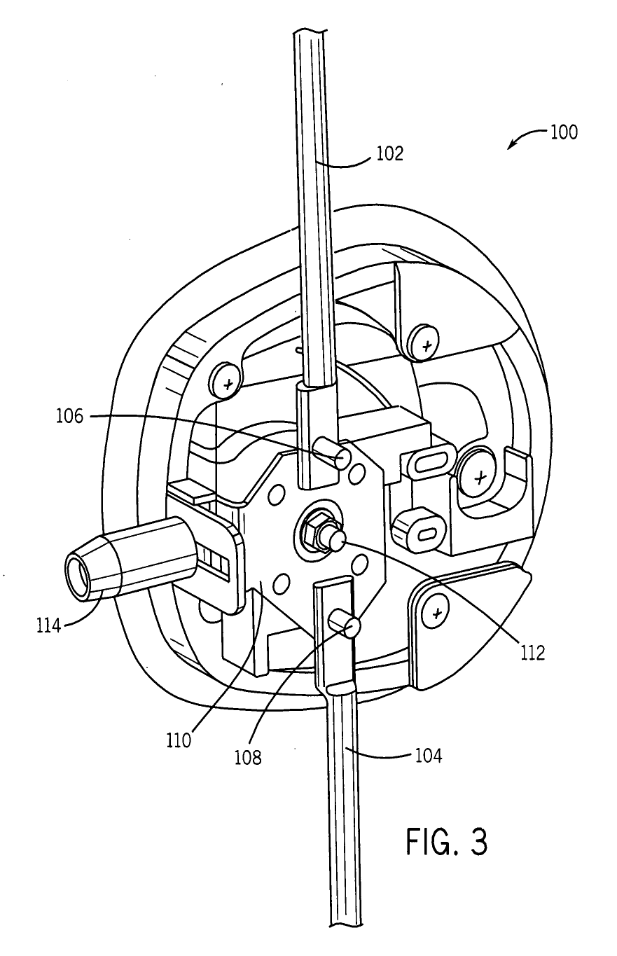

FIG. 2 illustrates an isometric view of a partially closed latch mechanism 100. The latch mechanism includes the same relative components as the latch mechanism 100 of FIG. 1, however the position of the rod latch pins 106 and 108 are illustrated in the 10:30 and 4:30 positions, respectively. The latch mechanism 100 includes a support plate, 110 rotatable around a shaft 112. The support plate 110 is turned by force applied to a lever arm formed by a handle 114 together with a respective radial portion of the support plate 110 to continue closing the latch 100. The rotation of the plate 110, to which the rod pins 106 and 108 are perpendicularly attached, forces the latch rods 102 and 104 to extend, respectively, in an upward and downward direction. A skilled artisan will appreciate that the effective length of the first lever arm in the particularly closed latch mechanism 100 as depicted in FIG. 2, has increased with respect to the effective length of the first lever arm in the open latch mechanism 100, as illustrated in FIG. 1. At the same time, as the skilled artisan will appreciate, the effective length of the second lever arm in the partially closed latch mechanism 100 has significantly decreased with respect t the effective length of the second lever arm in the open latch mechanism 100. As such, the input force necessary to move the latch rods 102 and 104 towards the engaged position, continuously decreases as the latch means advances to the door latch close position. It will be understood by those skilled in the art that the closer the latch mechanism 100 becomes to the closed position depicted in FIG. 3, the less force is required to turn the handle 114, i.e., close, the latch 100. It will be understood by those skilled in the art that the latch rods 102 and 104 are advantageously designed so as to engage side walls of a compartment, the top and bottom walls of a compartment, or any combination thereof.

Referring now to FIG. 3, there is shown an isometric view of a latch mechanism 100 for a truck body compartment door, wherein the latch mechanism 100 is in the closed position. The latch mechanism 100 includes at least two latch rods, illustrated in FIG. 3 as the top latch rod 102 and the bottom latch rod 104. The mechanism 100 also includes a support plate 110, from which perpendicularly extend a top rod latch pin 106 and a bottom rod latch pin 108. The skilled artisan will appreciate that as shown in FIG. 3, the rod latch pins 106 and 108 are at the 12:00 and 6:00 positions, indicating that the latch mechanism 100 is in the closed position. It will be appreciated by those skilled in the art that to open the latch mechanism 100 of FIG. 3, a force is suitably applied to the handle 114 to move the handle 114 counterclockwise. The handle 114 together with a respective radial portion of the support plate 110 functions as a first lever arm to rotate the plate 110 around a shaft 112. Another radial portion of the support plate 110 located between the shaft 112 and a respective rod latch pin 106 and 108 suitably serves as a second lever arm. The rod latch pins 106 and 108 are attached to the shaft 112. Hence, the rotation of the plate 110 serves to turn the rod latch pins 106 and 108 so as to force the latch rods 102 and 104, respectively, to retract from the close position thereby disengaging the rods 102 and 104 from the locking slots (not shown) of the compartment door.

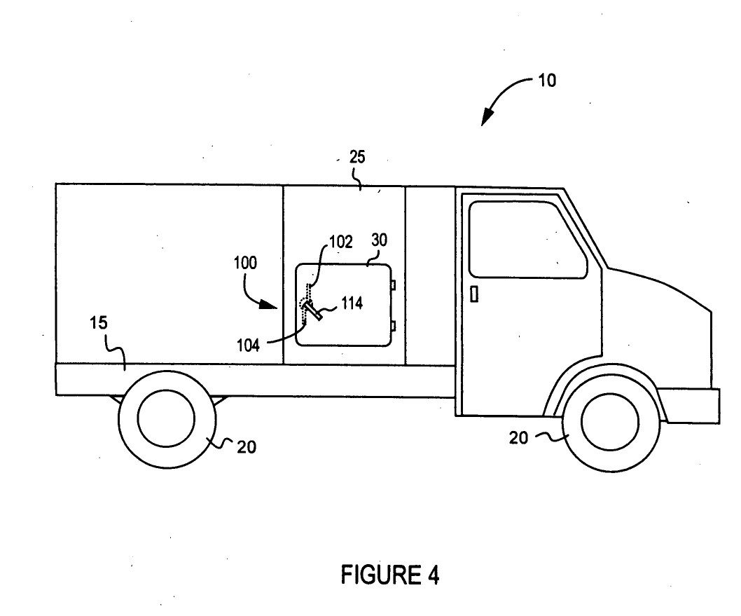

Referring to FIG. 4, a vehicle 10 is shown according to an exemplary embodiment. Vehicle 10 is (shown as a services truck) includes a support structure 15 (e.g. frame, bed, platform, chassis etc.) and one or more support member 20. According to various exemplary embodiments, support members 20 may be wheels, trucks, or any other member that are in communication with both the ground and the support structure 15. A storage compartment 25, having a door 30, is coupled to the support structure. The door 30 includes a door latch mechanism 100 configured to secure the door 30 in a closed position. The door latch mechanism 100 can be oriented to operate in a vertical or horizontal manner.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature.

The foregoing description of a compartment door latch mechanism has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A compartment door latch mechanism comprising:
a support plate rotatably mounted on a shaft;
at least two latch rod pins affixed to the support plate at substantially equal predetermined distances from the shaft, the at least two latch rod pins extending substantially orthogonally from the support plate;
a first latch rod and a second latch rod coupled to the support plate via respective associated latch rod pins, the first and second latch rods having respective substantially opposed initial orientations;
a handle configured to facilitate the rotating of the support plate;
wherein the first and second latch rods are configured to transplace in a plane substantially parallel to the support plate to be engaged in a door latch close position and in a door latch open position;
wherein the handle, the first latch rod, and the second latch rod are spatially disposed such that in the door latch close position a projection of the handle into a plane associated with the support plate is characterized by a first predetermined angular position relative to a projection onto the plane associated with the support plate of at least one of the first latch rod and the second latch rod.

2. The compartment door latch mechanism of claim 1, wherein in the door latch open position the projection of the handle onto the plane associated with the support plate is characterized by a second predetermined angular position relative to a projection onto the plane associated with the support plate of the at least one of the first latch rod and the second latch rod.

3. The compartment door latch mechanism of claim 1, wherein the first and second latch rods are configured to maintain their respective initial orientation.

4. The compartment door latch mechanism of claim 1, wherein the first predetermined angular position is such that the angular distance between the projection of the handle and the projection of the at least one of the first latch rod and the second latch rod is substantially 90 degrees.

5. The compartment door latch mechanism of claim 2, wherein the second predetermined angular position is such that the projection of the handle is parallel to the projection of the at least one of the first latch rod and the second latch rod.

6. The compartment door latch mechanism of claim 3, wherein the initial orientation of the first latch rod is an upward orientation, the initial orientation of the second latch rod being a downward orientation.

7. The compartment door latch mechanism of claim 6, wherein in the door latch close position the at least two latch rod pins are substantially in 12:00 and 6:00 positions, respectively.

8. The compartment door latch mechanism of claim 6, wherein in the door latch close position the at least two latch rod pins are substantially in 9:00 and 3:00 positions, respectively.

9. A compartment door latch mechanism, comprising:
a support member configured for rotating under an influence of input force;
a latch coupled to the support member, the latch being configured for transplacing in a plane substantially parallel to the support member to be engaged in a door latch close position and in a door latch open position; and
a lever including a first arm and at least one second arm, the first arm being configured for receiving input force and having a first effective length, and the at least one second arm being configured for delivering output force to the latch and having a second effective length;
wherein the lever is configured for respective changing of the effective lengths of the first and the at least one second lever arms such that the input force necessary for transplacing the latch continuously decreases as the latch advances to at least the door latch close position.

10. The compartment door latch mechanism of claim 9, further comprising a handle member coupled to the support member.

11. The compartment door latch mechanism of claim 10, wherein the support member is rotatably mounted on a shaft, the shaft serving as the lever fulcrum.

12. The compartment door latch mechanism of claim 11, wherein a radial portion of the support member extending from the shaft to the handle member in conjunction with the handle member serves as the first lever arm, wherein a radial portion of the support member extending from the shaft to the point of coupling of the latch to the support member serves as the at least one second lever arm.

13. A vehicle comprising:
a support platform;
a support member coupled to the support platform and configured to engage a surface;
a compartment coupled to the support platform and including a door; and
a compartment door latch mechanism coupled to the door, the compartment door latch mechanism comprising:
a support plate rotatably mounted on a shaft and coupled to the door;
at least two latch rod pins affixed to the support plate at substantially equal predetermined distances from the shaft, the at least two latch rod pins extending substantially orthogonally from the support plate;
a first latch rod and a second latch rod coupled to the support plate via respective associated latch rod pins, the first and second latch rods having respective substantially opposed initial orientations;
a handle configured to facilitate the rotating of the support plate;
wherein the first and second latch rods are configured to transplace in a plane substantially parallel to the support plate to be engaged in a door latch close position and in a door latch open position;
wherein the handle, the first latch rod, and the second latch rod are spatially disposed such that in the door latch close position a projection of the handle into a plane associated with the support plate is characterized by a first predetermined angular position relative to a projection onto the plane associated with the support plate of at least one of the first latch rod and the second latch rod.

14. The vehicle of claim 13, wherein in the door latch open position the projection of the handle onto the plane associated with the support plate is characterized by a second predetermined angular position relative to a projection onto the plane associated with the support plate of the at least one of the first latch rod and the second latch rod.

15. The vehicle of claim 13, wherein the first and second latch rods are configured to maintain their respective initial orientation.

16. The vehicle of claim 13, wherein the first predetermined angular position is such that the angular distance between the projection of the handle and the projection of the at least one of the first latch rod and the second latch rod is substantially 90 degrees.

17. The vehicle of claim 14, wherein the second predetermined angular position is such that the projection of the handle is parallel to the projection of the at least one of the first latch rod and the second latch rod.

18. The vehicle of claim 15, wherein the initial orientation of the first latch rod is an upward orientation, the initial orientation of the second latch rod being a downward orientation.

19. The vehicle of claim 18, wherein in the door latch close position the at least two latch rod pins are substantially in 12:00 and 6:00 positions, respectively.

20. The vehicle of claim 18, wherein in the door latch close position the at least two latch rod pins are substantially in 9:00 and 3:00 positions, respectively.
